(19) United States
(12) Patent Application Publication
(10) Pub. No.: US 2009/0067196 A1
(43) Pub. Date: Mar. 12, 2009

(54) SURFACE LUMINOUS BODY

(76) Inventors: Hiroaki Takada, Shizuoka (JP); Masaru Hashimoto, Hokkaido (JP); Tsuneo Shibano, Chiba (JP); Toshihiko Maeno, Tokyo (JP)

Correspondence Address: Kathy Manke;Avago Technologies Limited, 4380 Ziegler Road, Fort Collins, CO, 80525, US

(21) Appl. No.: 11/779,789

(22) Filed: Jul. 18, 2007

(30) Foreign Application Priority Data
Jul. 18, 2006 (JP) 2006-195589

(51) Int. Cl. F21V 7/04

(52) U.S. Cl. 362/624

(57) ABSTRACT

A surface luminous body comprises a light guiding body, a coating layer formed by applying a binder paint where a reflecting material is mixed into and dispersed in a binder onto a surface of the light guiding body, and a reflecting layer made of a pigment layer which is formed by applying a pigment containing binder paint where a pigment is mixed into and dispersed in a binder onto the coating layer, wherein the average particle diameter of the mixed beads is 1 μm to 80 μm, and the pigment is opaque and made of a light reflecting material.

### CROSS REFERENCE TO RELATED APPLICATION

This application is entitled to the benefit of Japanese Patent Application No. 2006-195589, filed on Jul. 18, 2007, which is incorporated herein by reference.

### FIELD OF THE INVENTION

The present invention relates to a surface luminous body, such as a backlight used for a liquid crystal display and the like, and in particular, to an edge light type light guiding body in which light from a light source enters through an end surface of the light guiding body, and a surface luminous body where a reflecting layer is provided on the surface.

### BACKGROUND OF THE INVENTION

Liquid crystal display bodies have come to be used as displays for cellular phones, PDA (personal data assistant) electronics, automobiles, home electronic and various other types of apparatuses together with developments in the field of information and communications. These liquid crystal display bodies do not themselves emit light, and therefore, a light emitting body in flat form is provided on the rear surface of the liquid crystal display body, that is to say, a backlight is provided, or a light emitting body is provided on the front surface of the liquid crystal display body, that is to say, a front light is provided, making display possible using reflection. Such displays are generally referred to as liquid crystal displays.

Transmission type liquid crystal displays using a backlight use either an edge light type backlight for allowing light from a light source to enter through an end surface of the light guiding body in flat form or a directly-behind type backlight where a light source in tube form is placed directly behind the display body via a diffusing plate. Directly-behind type backlights are generally used for a screen size of 15 inches or larger. The light guiding body, which guides light from a light source to the light emitting surface, is manufactured from a material having excellent light transmitting properties, such as a transparent acryl, polycarbonate or methacrylic resin, through injection molding or compression molding. The edge light type backlight is a system where a cold cathode tube or a light source in linear form where a number of LEDs are aligned is installed against an end surface of the light guiding body, which is a surface through which light enters, and therefore, can be implemented as a backlight which is thinner than directly-behind types. Thus, the majority of compact and portable type liquid crystal displays use an edge light type backlight.

FIG. 5 shows a typical configuration for a conventional edge light type backlight. In order to efficiently take out light emitted from a light source 509 as uniform surface light, a reflecting sheet 502 is placed on the reflecting surface side of a light guiding plate 501, and a diffusing sheet 503 for increasing the uniformity in the brightness by diffusing light is layered on the light emitting surface side, and condensing prism films 504 and 505 for bending light that has diffused toward the front, as well as a diffusing sheet (not shown) are layered on top of the diffusing sheet. Thus, conventional edge light type backlights generally have a configuration where a light guiding plate 501 and optical member sheets having various functions are provided in a multilayer structure.

Various forms, such as aventurine, prism, microscopic protrusions or recesses, or printed dots, can be provided on the light reflecting surface and the light emitting surface of the light guiding plate at the time of molding or through a discharging process, a laser process or the like, in order to gain uniform and bright surface light. In addition, means for reflecting light (not shown) is usually provided, in order to increase the brightness by returning light which leaks from the end surface which faces the surface through which light enters on the light source side, and the end surface on the two sides to the inside of the light guiding plate. In backlights having such a configuration, however, there are problems, such that a great number of optical sheet members of a great number of types are required, the cost of raw materials is high, assembly takes time and the backlight itself becomes expensive. In order to solve these problems, Japanese Patent Application Publication No. 2005-135760 (Patent Document 1) and Japanese Patent Application Publication No. 2005-251655 (Patent Document 2) disclose means for reducing the number of optical members. In these, thermoplastic resins having excellent light transmitting properties, for example, an acryl resin, a methacrylic resin, a polycarbonate resin, and a methacrylate ester-aromatic vinyl compound copolymer resin, are proposed as the material for the light guiding plate.

In addition, Japanese Patent No. 03-256090 A (Patent Document 3) describes that a diffuse reflecting layer formed through screen printing is provided on the light emitting surface of a transparent resin, which forms an edge light type light guiding body, and microscopic hollow particles or hollow microscopic particles made of a resin are mixed into this ink by foaming, and thus, the brightness of the light guiding body panel increases.

In addition, two prism type condensing films are generally used in order to increase the brightness of the light emitting surface of backlights having a conventional multilayer structure (FIG. 5), and the cost of these is high in comparison with other component members, and therefore, means for reducing the cost while maintaining the brightness is proposed. In order to achieve this object, a light guiding body in a variable pitch reflecting groove system having light diffusing properties of a special type is proposed, and thus, provision of one prism condensing film is proposed, as described in “Intensified Brightness Backlight for Cellular Phones,” Hitachi Chemical Technical Report No. 42, p 39.

Reduction in the weight and thickness has always been pursued for information apparatuses, as well as for backlights, in order to increase the portability. Furthermore, displays may take any form in the future, and therefore, light guiding bodies which are flexible and thus can be mounted on and make contact with a surface having unevenness to a certain degree inside apparatuses are desired. However, in all of the above described patent documents, the light guiding body is gained by processing a thermoplastic resin through injection molding, and thus, not flexible. Therefore, when the size is approximately 40 mm×60 mm, the light guiding body warps, due to distortion resulting from internal stress at the time of molding, and there is a limit in terms of to what degree the thickness of light guiding bodies can be reduced. So far, a thickness of 0.2 mm to 0.4 mm has been the limit.

In addition, the above described Patent Document 3 proposes formation of a reflecting layer using screen printing. In the case of screen printing, however, a reflecting material, such as beads, is mixed into a relatively large amount of ink, which is then printed on a light guiding body, and therefore, the gained reflecting layer is thick and the density of the beads dispersed in the layer is not high in the vicinity of the surface of the light guiding body. That is to say, though it is basically desired for the density of the reflecting material to be high in the vicinity of the surface of the light guiding body, it is difficult to control this. Accordingly, it is difficult in screen printing to control the location in which the reflecting material is applied with precision, and thus, the density of the reflecting material does not become high in the vicinity of the surface of the light guiding body. As a result, the efficiency of reflection of light which enters into the light guiding body does not increase. Accordingly, a coating where the density of the reflecting material is high in the vicinity of the surface of the light guiding body so that the efficiency of reflection increases is desired.

In addition, the lifecycle of so-called information apparatuses are getting shorter every year, and the lead time for development is extremely short at present, so that there are some apparatuses where models constantly change, almost three times a year. When this is compared to the development of backlights, the cost of molds for forming the light guiding plate is extremely high, and therefore, the cost for development becomes tremendous when various types of light guiding bodies are developed in a short period of time, which has become an inevitable factor raising the price of light guiding bodies.

Accordingly, development of an inexpensive surface luminous body which does not need an expensive mold, so that, for example, a sheet is formed through extrusion molding and this can be used as a light guiding body, has been desired.

### SUMMARY OF THE INVENTION

An object of the invention is to provide an inexpensive, flexible and thin surface luminous body having a high productivity with which a reduction in the thickness of the edge light type backlight can be achieved.

A surface luminous body in accordance with an embodiment of the invention comprises a light guiding body, a coating layer formed by applying a binder paint where a reflecting material is mixed into and dispersed in a binder onto a surface of the light guiding body, and a reflecting layer made of a pigment layer which is formed by applying a pigment containing binder paint where a pigment is mixed into and dispersed in a binder onto the coating layer, wherein the average particle diameter of the mixed beads is 1 μm to 80 μm, and the pigment is opaque and made of a light reflecting material.

In accordance with an embodiment, one surface of a thin light guiding body which is processed by extruding a transparent thermoplastic resin is spray coated with a paint prepared by melting a resin which is of the same type as the light guiding body or a resin (binder) which is compatible with the light guiding body and mixing a reflecting material (beads) into the melt, which is dried afterwards so that a reflecting material containing coating is formed. Furthermore, the coating layer is spray coated and layered with a binder paint into which a pigment is mixed so that a pigment containing layer is formed, and thus, a surface luminous body which has this as a reflecting layer is provided. In addition, portions other than the portion of the light guiding body in sheet form into which light enters through the end surface on the light source side and/or one or more end surfaces other than the end surface on the light source side are spray coated with a binder paint into which a reflecting material is mixed and a binder paint into which a pigment, such as an aluminum powder, is mixed, so that a pigment layer or a reflecting layer is provided. As a result, further increase in the brightness of the light emitting surface can be achieved. In addition, gradation can be provided in the density of the reflecting material and the density of the pigment in the sprayed coating on the reflective layer and the end surface.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a schematic diagram showing a main portion of an edge light type surface luminous body according to an embodiment of the present invention.

FIG. 2 is a diagram showing an enlarged image of FIG. 1.

FIG. 3 is a plan diagram of FIG. 1.

FIGS. 4(a) and 4(b) are a plan diagrams showing other embodiments of the present invention.

FIG. 5 is a diagram showing the configuration of a conventional edge light type backlight.

### DETAILED DESCRIPTION

A surface luminous body in accordance with an embodiment of the invention is formed of (1) a light guiding body, (2) coating layer wherein a reflecting agent containing binder paint where cross-linking beads made of a synthetic resin, inorganic based beads or a metal powder is mixed and dispersed in a binder is applied on the surface of the light guiding body, and (3) a pigment layer formed by applying a pigment containing binder paint where a pigment is mixed into and dispersed in a binder applied on the coating layer, wherein the average particle diameter of the beads or metal powder which are the above described reflecting material mixed into the coating layer of (2) is 1 μm to 80 μm and the above described pigment is opaque and made of a light reflecting material. As for the surface luminous body, the manufacture is easy and the cost is low, and in addition, the thickness of the light guiding body is small, and therefore, a surface luminous body which is thin as a whole, flexible and has a high brightness can be provided.

According to an embodiment of the present invention, a coating layer and a pigment layer can be printed through indirect printing, desirably spray coating, and thus, the coating layer and the pigment layer can be cured in several seconds, respectively, and highly productive manufacture becomes possible.

According to an embodiment of the present invention, a thermoplastic resin having high optical transparency, that is, a thermoplastic resin of which the light transmittance is preferably no less than 80%, preferably no less than 90, more preferably no less than 95%, which is usually formed in sheet form, is used as the light guiding body in an edge type surface luminous body, which is a key part of backlights. Furthermore, a flexible thermoplastic resin is used for the light guiding body according to an embodiment of the present invention. As examples of such thermoplastic resins, ionomer resins for which extrusion processing is possible, polyurethane resins which do not turn yellow, ethylene-acrylate copolymer resins, ethylene-ethyl acrylate copolymer resins, ethylene-vinyl acetate copolymer resins, ethylene-methacrylate copolymer resins, polyamide resins, polyester resins, polyolefin resins, polybutadiene resins, fluorine resins, silicon resins and triblock-diblock copolymers can be included. In the case where the apparatus is used outdoors, polyurethane resins which do not turn yellow are preferable.

In addition, though a sheet is usually fabricated of the thermoplastic resin which is the material of the light guiding body in accordance with an embodiment of the present invention through extrusion molding, other methods for formation, such as injection molding methods, compression molding methods and coating methods, can be adopted.

A transparent film can be formed through protrusion processing, by controlling the temperature at which the resin is heated and melted and the rate of protrusion, and therefore, the thickness of the light guiding plate can be reduced to as small as several tens of microns. However, the absolute amount of light for the surface luminous body becomes insufficient in the case where the edge area becomes too small, and various thicknesses have been examined in terms of the ease with which light entering from a light source LED can be taken in, and as a result, it was found that it is possible to reduce the thickness of the light guiding body to as small as approximately 0.1 mm when the area of the luminous surface is small.

As the material for the light guiding body, any type of thermoplastic resin which is optically transparent and of which the normal light transmittance is 80% or more, preferably 90% or more, and the extrusion molding allows the resin to be continuously extruded from the extrusion molding machine at 1 m/min to 20 m/min, pated with a separator, quickly and sufficiently cooled, and cut to a certain length without being rolled up. The thickness of the sheet differs depending on the application for the surface luminous body, and usually the thickness is 0.02 mm to 3.0 mm, preferably 0.1 mm to 3.0 mm. The sheet may have a uniform thickness, or the thickness may be partially different. For example, a sheet of which the thickness becomes gradually smaller from one side to the other side can be used. These sheets cut into bands are covered with a separator, and therefore, the surface pattern of the separator is transferred and generated in such a manner that in the case where light enters a transparent sheet having a thickness of approximately 0.2 mm from a light source which is provided against an end surface, light goes straight and repeats total reflection on the two surfaces of the light guiding body, and reaches the end surface facing the light source side. The hardness of this light guiding body is determined by the mixture of the material and the conditions for manufacture at the stage where the thermoplastic resin material is polymerized.

Next, the configuration of the reflecting surface facing the light emitting surface is described. In the case where an edge light type light source into which light enters through an end surface of the light guiding body is provided on one end surface, light that enters goes straight, and thus, does not come out in the direction of the plane of the light guiding plate. Therefore, a so-called reflecting surface which faces the light emitting surface is coated with a resin (binder) which is compatible with the resin for forming the light guiding body, in which a reflecting material having microscopic particles of which the size is several μ, for example inorganic based beads, such as glass micro-beads, are dispersed, which is forcefully sprayed from a nozzle. A group of microscopic lenses is molded in the reflecting layer of the light guiding body in this process (micro-lens coating; referred to as MLC). This lens group makes light that enters through an end surface (edge) diffuse reflect from the reflecting layer and directs the light toward the light emitting surface. It is preferable for the material for the beads used to diffuse reflect introduced light in an embodiment of the present invention to be optically transparent and have a high index of refraction. Though inorganic based beads, such as micro-glass beads, micro-silica beads and silicon beads, and synthetic resin based cross-linking beads, such as cross-linking urethane beads, cross-linking acryl beads, cross-linking polycarbonate beads and cross-linking styrene beads, are appropriate, inorganic opaque reflective materials, such as precipitating barium sulfate and metal fine powder, which are other opaque materials which cause diffuse reflection, can be used for the same purpose. The average particle diameter of the beads or metal powder is 1 μm to 80 μm, preferably 2 μm to 40 μm. Naturally, appropriate beads made of other materials can also be used, as long as the object of the present invention can be achieved.

The thickness of the flexible light guiding body according to an embodiment of the present invention is usually uniform because of the manufacturing method, and therefore, uniformity cannot be secured for the luminous surface in the case where the microscopic lens (beads) group is uniformly distributed. That is to say, the closer to the light source, the higher the brightness, and the farther away from the light source, the more attenuated the light. In order to reduce this difference so as to gain a uniform brightness throughout the entire surface, the density of the lens group gradually increases in the direction away from the light source. That is to say, it becomes possible to make the emitted light uniform by creating gradation. It is extremely easy to control this change in the density through indirect printing, that is to say, printing through spray coating, ink jet, bubble jet (registered trademark) and the like, and therefore, these are desirable techniques according to an embodiment of the present invention.

This micro lens coating method not only makes it possible to create gradation in the reflecting body, but also to provide a reflecting layer in a predetermined form and in a predetermined location on the surface facing the light emitting surface through masking so that light is locally emitted from the surface luminous body. Accordingly, a reflecting layer having desired figures, letters and the like is provided, or the reflecting layer is partially masked, and thus, figures, letters and the like can be freely formed on the transparent light guiding body for emitting light.

The pigment layer of an embodiment of the present invention can be formed by applying a resin which is the same as the binder resin that forms the coating layer or compatible with the binder resin into which a pigment is dispersed on the coating layer. As the pigment that can be used in the pigment layer according to an embodiment of the present invention, a white pigment is preferable. Inorganic pigments, such as titanium white (TiO₂), for example rutile type titanium dioxide, zinc white (ZnO), barium sulfate (BaSO₄), for example precipitating barium sulfate, and chalk (CaCO₃), can be included. Furthermore, metal fine powder having excellent light blocking properties and excellent light reflecting properties, for example a powder of gold, platinum or aluminum, can be used as the pigment according to an embodiment of the present invention.

In addition, the light guiding body according to an embodiment of the present invention can be used in any form, not only in sheet form, but also in spherical form, rectangular parallelepiped or cubic form, or rod form with a circular, semicircular, triangular or quadrangular cross section. For example, the reflecting layer on the surface facing the luminous surface of the rod can be coated so that a rod having a luminous surface of light that enters through an end portion is gained. The same goes for light guiding bodies in other forms.

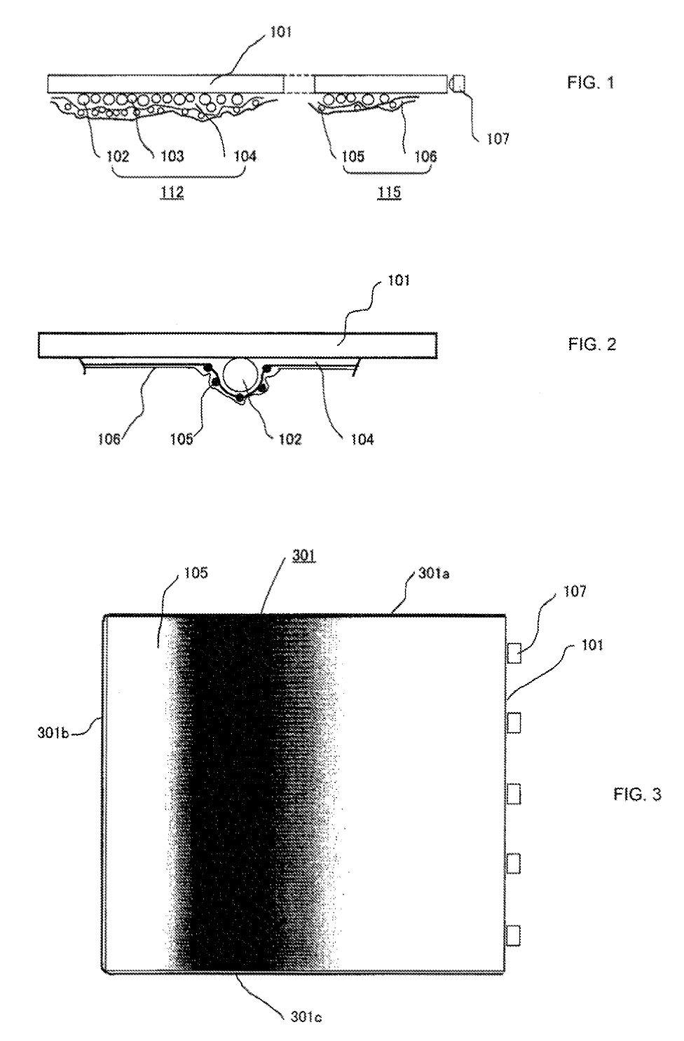

In the following, the embodiments for carrying out the invention are described in detail in reference to FIGS. 1 to 4.

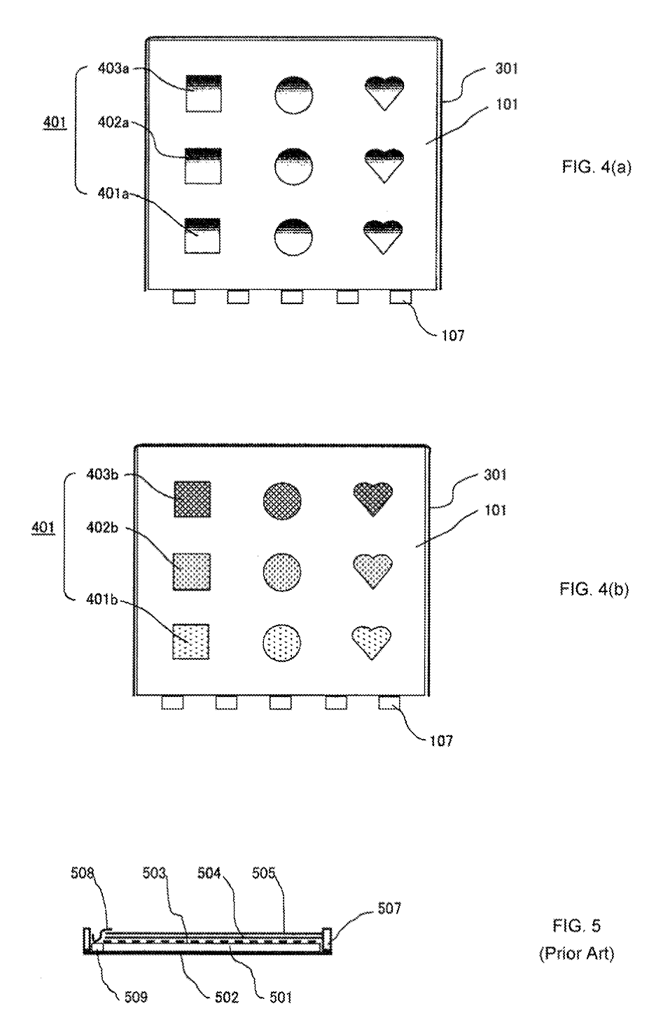

FIG. 1 is a schematic diagram showing the main portion of an edge light type surface luminous body using the light guiding body according to an embodiment of the present embodiment. The thickness of the light guiding body, a reflecting material, a pigment and the binder paint, in which a resin of the same type as that of the light guiding body is dissolved, are depicted for the purpose of explanation, and the ratio of the dimensions of these does not coincide with the actual ratio. FIG. 2 is a diagram showing an enlarged image of FIG. 1, and FIG. 3 is a plan diagram of the edge light type surface luminous body of FIG. 1. In addition, FIGS. 4(a) and 4(b) show other embodiments of the present invention. FIG. 5 is a diagram showing a typical configuration of a conventional edge light type backlight as described above.

An embodiment of the present invention relates to the processed surface structure of the light guiding body which forms an edge light type backlight, such as a liquid crystal display, and the diffuse reflecting layer placed on this reflecting layer. A polyurethane resin sheet that has been converted to a sheet through an extrusion process is cut into bands which are spray coated with a cross-linking polymerization type transparent urethane resin paint or a water soluble polyurethane resin paint using a spraying apparatus having a nozzle.

Thermoplastic polyurethane resin, which does not turn yellow and has a light transmittance of 90% or more, is used as the light guiding body 101 in FIGS. 1 and 2. Though the thickness is 0.2 mm for the purpose of reduction in the size of the apparatus, the invention is not limited to this, and a light guiding body can be manufactured when the thickness is 0.1 mm. However, loss becomes great unless a further reduction in the size and an increase in the brightness of LEDs progress. The hardness of the light guiding body 101 is shore A 90 to 97. Sheets having this hardness are flexible and can be bent easily. The flexibility is not limited to this range and can be selected from the ranges where shore A is 60 to 97, preferably, 80 to 97, and more preferably, 90 to 97, and the range where shore D is 50 to 80. This means the sheet can be flexibly incorporated into the used apparatus, and a backlight can be formed in a portion where there is a step in the upward and downward direction or in a form extending along a curved portion, which was impossible with a conventional hard light guiding body.

As the reflecting materials 102 and 103, spherical micro-glass beads, cross-linking urethane beads, cross-linking acryl beads and the like are appropriate, and the average particle diameter thereof is 1 μm to 80 μm, preferably 2 μm to 40 μm. These reflecting materials are dispersed in a binder paint 104 which is compatible with the light guiding body material and sprayed through a spray nozzle for spray coating. This coating with reflecting materials may be carried out as spray coating, or as an ink jet printing or bubble jet printing method. When the reflecting material is applied on the reflecting layer with uniform density, the brightness becomes high toward the light source, and the brightness becomes lower at a distance from the light source, because the thickness of the light guiding body 101 is constant. In order to correct this so that the brightness becomes uniform throughout the entire surface, so-called gradation application is carried out, where the coating density of the reflecting material on the light source side is low and the density becomes higher at a distance from the light source. Though gradation application can be carried out in accordance with a conventional method, indirect printing, for example spray coating, is preferable. In accordance with spray coating, microscopic lens (beads) groups where binder paint in layer form surrounds the curved surface of the particles in the reflecting material are created, and therefore, the reflection efficiency increases, and at the same time, stability and uniformity are high in comparison with other printing methods. Thus, this can be said to be a method having extremely high productivity. In the case where a light guiding body having dimensions of 30 mm×40 mm×0.2 mm is coated, high productivity is possible, so that approximately 20 sheets can be produced every 3 seconds. As the binder paint used here, a urethane resin of the same type as the light guiding body 101 is used. A two-liquid type polyurethane paint or commercially available water soluble polyurethane resin paint including an active hydrogen compound of which hydroxyl group is 10 to 500/mol, glass transition temperature is −30° C. to 80° C., active hydrogen containing silicon and multifunctional isocyanate, which are mixed with a chemical equivalent ratio (NCO/OH) of 0.2 to 2.0 is adopted, so that excellent strength of adhesion can be gained.

Next, as means for further increasing the brightness, according to an embodiment of the present invention, 10 parts by weight to 20 parts by weight of a rutile type titanium dioxide pigment 105 is mixed into 100 parts by weight of a urethane binder paint 106 and a pigment layer is layered on the above described reflecting material sprayed coating layer through similar gradation spray coating, and then, the brightness of the emitted light doubles, due to refraction in the interface between the lens (beads) groups and the pigment layer, and the effects of reflection of the pigment. FIG. 2 is the enlarged schematic diagram.

Next, means for further increasing the brightness is described in reference to FIG. 3.

In the case where the light guiding body is made of a material having a high hardness and a thickness of 1 mm to 2 mm or greater, light which leaks from an end surface other than the light source is reflected into the light guiding body as a result of mechanical buff polishing and conversion to a mirror surface of the end surface or pasting of a reflecting tape and printing or an ink containing a reflecting material, and thus, the brightness can be increased by 10% or more, and this is publicly known technology. However, the above described means cannot be adopted for soft and flexible light guiding bodies which are sheets having a thickness of only 0.2 mm. Therefore, the inventors overlapped light guiding bodies in a bundle and spray coated the sides thereof after completing an MLC process on the reflecting layer described above, and furthermore, spray coated end surface portions other than the portion of the end surface on the light source through which light enters and/or one or more end surface other than the end surface on the light source with a binder paint into which an aluminum powder having excellent masking properties and reflecting properties was mixed as a pigment (105). Thus, effects of increasing the brightness in the same manner as in the prior art can be gained. In the following, formation of a pigment layer or a reflecting layer (coating layer and pigment layer) on an end surface is referred to as edge coating. The productivity is extremely high because of this method. The edge coatings 301a and 301c in FIG. 3 have gradation such that the pigment density changes from coarse to dense at a distance from the light source, and this contributes to increase in the brightness, in addition to increase in the level of uniformity on the luminous surface. Here, the pigment used may be a pigment having excellent light locking properties and excellent light reflecting properties, for example metal fine powder or the like, but is not limited to an aluminum powder.

FIGS. 4(a) and 4(b) show other embodiments of the MLC. An object thereof is to provide means for making a uniform luminous surface, which is an edge light where means for emitting light only in a necessary form on the light guiding body and a light source is on one end surface. In the case where the MLC is applied on the entire surface of the reflecting layer of the light conducting body in the surface luminous body into which light from such a light source as an LED enters through one end surface of a uniform flexible light guiding body having a thickness of 0.2 mm, the amount of emitted light is reduced, due to light reflection, absorption and transmission phenomena. Accordingly, the brightness in the light emitting portion becomes higher for the same light source when only a necessary portion emits light.

In FIG. 4(a), an MLC process is carried out on a light guiding body 101 in patterns 401a to 403a, and in the case where the density required for MLC can be controlled between 0% to 100%, spray coating is carried out so that the pattern 401 a has such gradation that the MLC density is 0% to 16%, the pattern 402a has such gradation that the MLC density is 16% to 60%, and the pattern 403a has such gradation that the MLC density is 60% to 100%. In this manner, the MLC density is changed in accordance with the distance from the light source, and thus, the respective patterns, of which the distance from the light source is different, can emit light uniformly. There is an advantage in spray coating such that the density for each pattern can be easily changed in this manner. FIG. 4(a) shows means which is effective when the patterns are great and the number is small.

FIG. 4(b) is advantageous for use when the individual patterns are small and the number of patterns is great. MLC is carried out with a ratio of 10% in pattern 401b, 20% in 402b, 30% in 403b . . . , so that all of the patterns have the same intensity of light emission throughout the entirety. In this case, there is no gradation in each pattern. These are referred to as pattern lens (beads) coating 401 (hereinafter referred to as PLC). Here, in the case of PLC, indirect printing, such as ink jet or bubble jet, offset printing and silk printing can sometimes be used, in addition to the above described method for spray coating. In the case of FIG. 4(b), 100 to 2000 circles having a diameter of 4 μm to 6 μm per 1 cm² of luminous surface are formed through spraying or printed, in order for the surface to emit light uniformly.

Examples are illustrated as described above, and in the case where these can be used alone as a surface luminous body, the various types of optical functional sheets shown in FIG. 5 as the prior art become unnecessary, and therefore, the price can be tremendously reduced. In addition, it is obvious that optical functional sheets can be selected and combined for use depending on the required performance. Though the above described embodiments of the present invention are described assuming that a flexible thermoplastic polyurethane resin having high physical strength which does not turn yellow is used as the light guiding body, the present invention is not limited to this, and any transparent resin that can be formed through extrusion without using a mold can be used. It is preferable for a material which is compatible with the material of the light guiding body to be selected for the binder material that can be used as the binder paint for the spray. In addition, though an embodiment of the present invention described is for a luminous body in sheet form, a luminous body of which the cross section is in circular, quadrangular, semicircular or any of various other types of rope form on which a spray coating process can be carried out functions as a linear luminous body with light sources placed on the two end surfaces.

The surface luminous body according to an embodiment of the present invention does not require a mold, and therefore, can do with little initial investment, and thus, the period for development can be shortened and the productivity is extremely high, and therefore, a surface luminous body can be provided at low cost. In addition, since the thickness can be reduced, an embodiment of the invention can contribute to reduction in the thickness of apparatuses and a luminous body can be formed so as to fit in apparatuses with a step due to the flexibility, and furthermore, the luminous surface can be formed along a curved surface, and therefore, embodiments of the invention can be used in a broad range of fields, including those of IT apparatuses and signboards.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A surface luminous body, comprising:
a light guiding body;
a coating layer formed by applying a binder paint where a reflecting material is mixed into and dispersed in a binder onto a surface of the light guiding body; and
a reflecting layer made of a pigment layer which is formed by applying a pigment containing binder paint where a pigment is mixed into and dispersed in a binder onto the coating layer, wherein the average particle diameter of said mixed beads is 1 μm to 80 μm, and said pigment is opaque and made of a light reflecting material.

2. The surface luminous body according to claim 1, wherein said reflecting material is selected from cross-linking beads made of a synthetic resin, inorganic based beads or a metal powder.

3. The surface luminous body according to claim 1, wherein said light guiding body is formed of an optically transparent thermoplastic resin, of which the light transmittance is no less than 80% in sheet form, spherical form, rectangular parallelepiped or cubic form, or in rod form with a circular, semicircular, triangular or quadrangular cross section.

4. The surface luminous body according to claim 1, wherein the light guiding body is gained by cutting a sheet, of which the thickness in the thinnest portion is 0.02 mm to 3.0 mm, which is formed by extruding an optically transparent thermoplastic resin, of which the light transmittance is no less than 80%, so that the luminous body has a flexibility of 60 to 97 in the hardness shore A and 50 to 80 in the shore D.

5. The surface luminous body according to claim 1, wherein the coating layer is formed by coating a bead containing binder paint gained by mixing and dispersing 0.01% by weight to 5.0% by weight of cross-linking beads made of a synthetic resin or micro-glass beads into a binder, of which the base is the same as that of said light guiding body, onto at least a portion of a surface of said light guiding body through indirect printing, which is then dried, and the reflecting layer is gained by indirect printing a pigment containing binder paint where 10% by weight to 20% by weight of a pigment is mixed into a binder on said coating layer.

6. The surface luminous body according to claim 1, wherein indirect printing is spray coating, ink jet printing or bubble jet printing.

7. The surface luminous body according to claim 1, wherein gradation is provided to the density of the beads in the coating layer which is formed on the surface of said light guiding body.

8. The surface luminous body according to claim 1, wherein gradation is provided to the density of the pigment in the pigment layer which is formed on said coating layer.

9. The surface luminous body according to claim 1, characterized in that said coating layer and said pigment layer are formed on an end surface portion other than the portion of the light guiding body in sheet form into which light enters through the end surface on the light source side and/or on one or more end surfaces other than the end surface on the light source side.

10. The surface luminous body according to claim 1, characterized in that an end surface portion other than the portion of the light guiding body in sheet form into which light enters through the end surface on the light source side and/or onto one or more end surfaces other than the end surface on the light source side is spray coated with said pigment containing binder paint so that reflecting end surfaces are gained.

11. The surface luminous body according to claim 9, characterized in that an end surface portion other than the portion of the light guiding body in sheet form into which light enters through the end surface on the light source side and/or onto one or more end surfaces other than the end surface on the light source side is spray coated with a metal fine powder containing binder paint so that reflecting end surfaces are gained.

12. The surface luminous body according to claim 1, wherein gradation is provided to the density of the beads and/or the density of the pigment on said reflecting end surfaces so that brightness is increased and/or the uniformity in the brightness is increased.

13. The surface luminous body according to claim 1, wherein the coating layer and the pigment layer are formed on the light guiding body so as to have a pattern.

14. The surface luminous body according to claim 13, characterized in that the brightness of the light emitted from the pattern is made uniform by providing gradation to the density of the beads and/or the density of the pigment in the pattern.

15. The surface luminous body according to claim 13, wherein said pattern is formed through indirect printing, offset printing or silk printing.
